(19) United States
(12) Patent Application Publication
(10) Pub. No.: US 2025/0121985 A1
(43) Pub. Date: Apr. 17, 2025

(54) Mailer Assembly With Pockets

(71) Applicant: eBay Inc., San Jose, CA (US)

(72) Inventors: Robert William Clark, IV, Mattydale, NY (US); Thomas J. Picciott, West Monroe, NY (US)

(73) Assignee: eBay Inc., San Jose, CA (US)

(21) Appl. No.: 18/486,852

(22) Filed: Oct. 13, 2023

(51) Int. Cl. B65D 27/08; B43M 3/02

(52) U.S. Cl. CPC B65D 27/08; B43M 3/02

(57) ABSTRACT

An assembly for a mailer is described. The assembly supports the mailing of articles such as trading cards and includes an insert defining a set of pockets shaped to receive the articles. The pockets are formed between attachment members of the insert and are arranged adjacent to each other along a length of the insert. Each pocket includes an open end arranged toward an upper end of the insert formed by a terminating edge of the insert. Further, each pocket includes a closed end arranged toward a lower end of the insert and formed by a folded edge of the insert. In one or more implementations, the assembly further includes a backer and a spacer shaped to fit against opposing surfaces of the insert that increase a rigidity and flatness of the assembly.

### BACKGROUND

Shipments made via a postal service are often subject to processing via automation equipment such as mail sorters. Such automation equipment often includes rollers, conveyors, and other components configured to move and sort shipped objects such as envelopes. Additionally, automation equipment is often configured to detect whether size and weight parameters of shipments are in compliance with pre-determined criteria for various postage rates.

### SUMMARY

An assembly for a mailer is configured to support the mailing of articles such as trading cards while providing the mailer with rigidity and compliancy for sorting of the mailer via automation equipment. In one or more implementations, an assembly for a mailer includes a pocketed insert. The pocketed insert includes attachment members defining opposing sides of pockets formed between a front surface and a rear surface of the insert. The pockets are shaped to maintain the position of articles inserted into the pockets during mailing of the assembly via the mailer. In some implementations, the assembly includes a backer shaped to fit against a forward interior surface of the mailer and spacing apart the pocketed insert from the forward interior surface. In some implementations, the assembly further includes a spacer shaped to fit against a rearward surface of the mailer, opposite to the forward surface, and the spacer spaces apart the pocketed insert from the rearward surface.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIG. 1 is an illustration of an environment in an example implementation that is operable to employ techniques described herein.

FIG. 2 depicts an example of an assembly for a mailer.

FIG. 3 depicts a front view of an example pocketed insert of an assembly for a mailer in an unfolded configuration.

FIG. 4 depicts a rear view of the pocketed insert of FIG. 3 in the unfolded configuration.

FIG. 5 depicts a bottom view of the pocketed insert of FIGS. 3-4 in the unfolded configuration.

FIG. 6 depicts a top view of the pocketed insert of FIGS. 3-5 in the unfolded configuration.

FIG. 7 depicts a left side view of the pocketed insert of FIGS. 3-6 in the unfolded configuration.

FIG. 8 depicts a right side view of the pocketed insert of FIGS. 3-7 in the unfolded configuration.

FIG. 9 depicts a rear perspective view of the pocketed insert of FIGS. 3-8 in the unfolded configuration.

FIG. 10 depicts a front perspective view of the pocketed insert of FIGS. 3-9 in the unfolded configuration.

FIG. 11 depicts a front view of the pocketed insert of FIGS. 3-10 in a partially assembled configuration.

FIG. 12 depicts a rear view of the pocketed insert of FIGS. 3-11 in the partially assembled configuration.

FIG. 13 depicts a front perspective view of the pocketed insert of FIGS. 3-12 in the partially assembled configuration.

FIG. 14 depicts a front view of the pocketed insert of FIGS. 3-13 in a fully assembled configuration.

FIG. 15 depicts a rear view of the pocketed insert of FIGS. 3-14 in the fully assembled configuration.

FIG. 16 depicts a top-front perspective view of the pocketed insert of FIGS. 3-15 in the fully assembled configuration.

FIG. 17 depicts another example of a pocketed insert in an unfolded configuration.

FIG. 18 depicts another example of a pocketed insert in an unfolded configuration.

FIG. 19 depicts another example of a pocketed insert in an unfolded configuration.

FIG. 20 depicts another example of a pocketed insert in an unfolded configuration.

### DETAILED DESCRIPTION

### Overview

An assembly for a mailer is provided that supports the mailing of articles such as trading cards while providing the mailer with rigidity and compliancy for processing of the mailer via automation equipment. In one or more implementations, the assembly includes an insert defining a set of pockets shaped to receive articles to be shipped via the mailer. The pockets are formed between attachment members of the insert and are arranged adjacent to each other along a length of the insert. Each pocket includes an open end arranged toward an upper end of the insert formed by a terminating edge of the insert. Further, each pocket includes a closed end arranged toward a lower end of the insert and formed by a folded edge of the insert. In one or more implementations, the assembly further includes a backer and a spacer shaped to fit against opposing surfaces of the insert. In some instances, the backer and spacer are formed from different materials and increase a rigidity and flatness of the assembly. In one or more implementations, the backer and spacer are omitted, and the insert includes panels that fold to overlap the pockets to increase the rigidity and flatness of the assembly.

In various industries, postal shipments and mail are utilized to provide customers or other entities with products. For example, in the field of e-commerce, customers often order a product from a product provider by placing an order for the product over the Internet through a computer, smartphone, or other electronic device. In some instances, the product provider is a business, and in other instances, the product provider is an individual. The product provider accordingly prepares a postal shipment or mail including the product to be delivered to the customer via a postal service provider, such as the United States Postal Service (USPS). In some e-commerce implementations, the product order is received by the product provider, and the product provider relays the product order to a fulfillment center, such as a product warehouse. The fulfillment center then prepares the shipment or mail for delivery by the postal service provider.

Often, to reduce costs, product providers will prepare shipments or mail using receptacles sized according to a size of a product. For instance, it is often more cost effective to prepare shipment or mailing of smaller products using smaller receptacles slightly larger than the products themselves. Such approaches often reduce postage costs imposed by the postal service provider for delivery of the products. In some instances, small and thin products, such as trading cards, are deliverable as mail using receptacles such as envelopes. By preparing such articles for delivery as mail via envelopes instead of preparing such articles using boxes or other larger receptacles, postage costs may be reduced. However, reducing the size of the receptacles often increases a likelihood of degradation of the articles due to a reduced buffer between the articles and the environment.

Conventional approaches toward preparation of such articles for delivery include insertion or encapsulation of the articles within rigid receptacles such as rigid plastic or metal sleeves. The rigid receptacles are then sealed within envelopes for mailing, or the plastic or metal sleeves are integrated into the envelopes themselves. However, such approaches introduce a number of other challenges.

As one example, during conditions in which a rigid plastic or metal sleeve is sealed within a paper envelope, the rigidity of the sleeve often increases an occurrence of ridges, raised edges, or other pronounced features appearing at the exterior surfaces of the envelope, thereby reducing the flatness of the envelope. Such features often interfere with automatic processing equipment used by postal service providers for mail sorting, and envelopes including such features are often separated from other mail by the postal service providers for manual processing. However, postage rates associated with manual processing are often higher than postage rates associated with automatic processing. Therefore, envelopes including such sleeves that are mailed with postage appropriate for automatic processing often incur unexpectedly higher postage costs resulting from manual processing. As result, the mail is often returned to the product provider, resulting in increased costs, frustration, and delays.

Further, the increased occurrence of ridges and raised edges described above often results in degradation of the mail as the mail travels through postal service provider equipment. For example, as the mail comes into contact with rollers, conveyors, and other components of postal service provider equipment, the ridges and raised edges may come into contact with such components in undesirable and/or unexpected orientations, which may increase a likelihood of degradation of the envelope and the contents within. As a result, products often arrive to the customer unexpectedly degraded, which incur costs for replacement of the products and reduce customer satisfaction.

Thus, to solve the problems associated with the mailing of small articles such as trading cards, an assembly for a mailer is provided. In accordance with the described techniques, the assembly includes a pocketed insert employing attachment members to define the pockets of the insert. The insert is formed from a single sheet of a flexible material, such as a paper material having a first thickness. The insert includes various panels that are folded to engage with the attachment members. The interior surfaces of the panels thus further define the pockets of the insert. Additionally, the insert includes various flaps that engage with the panels. The panels and flaps together define the overall size and shape of the insert, and the pockets are shaped and sized to maintain a position of articles such as trading cards secured by the insert.

In some implementations, the assembly further includes a backer and a spacer. The backer is configured with a second thickness, larger than the thickness of the insert. In some instances, the backer is formed from a paper material, similar to or different from the material of the insert. The backer thus is configured with a higher rigidity than the insert and increases a rigidity of the assembly. The backer is substantially flat and planar such that during conditions in which the backer is positioned directly against the insert, the backer provides for a smooth, flat, and rigid surface opposite to the insert. Therefore, while the assembly is arranged within a receptacle such as an envelope, the backer increases a smoothness of the envelope and reduces a likelihood of ridges, raised edges, or other undesired protrusions of the envelope.

In some instances, the spacer is configured with a third thickness and is formed from a plurality of sheets. The sheets are formed from a material similar to, or the same as, the material forming the insert, such as a paper material. In some examples, each individual sheet is larger than the backer, and the sheets are folded to define the size of the spacer as approximately equal to the size of the backer. The resulting thickness of the spacer is less than the thickness of the backer, in some instances.

In some instances, the insert is formed from a first material having a thickness of approximately 0.0048 inches, and the backer is formed from a second material having a thickness between 0.014 inches and 0.018 inches. A composition (e.g., fiber or other material content) of the first material and the second material is the same, in some instances. In other instances, the composition of the first material and the second material is different, e.g., with the first material including a first amount of paper fiber content and with the second material including a second amount of paper fiber content. Further, in some instances, the first material and the second material each include more than 50% paper fiber content.

In this configuration, the assembly is shaped to fit within a receptacle such as an envelope in compliance with standards for automatic processing by USPS equipment. In some instances, the assembly is shaped to fit within a #10 envelope with dimensions equal to 9.5 inches in length and 4.125 inches in width. In some instances, the assembly is configured such that during conditions in which articles such as trading cards are seated within the pockets of the insert, the combined thickness of the insert, the backer, and the spacer is less than 0.25 inches.

Thus, according to the configurations described herein, the assembly supports the mailing of small articles such as trading cards while reducing a likelihood of degradation of the articles. Further, the features of the assembly described herein reduce a likelihood of degradation of the assembly itself as the mailer including the assembly is processed by mail sorters of a postal service provider such as the USPS.

In some instances, the assembly is in compliance with the USPS standards for automatic processing of mail as recited in the USPS Domestic Mail Manual (DMM) § 201.1.0, “Physical Standards for Machinable Letters and Cards,” the USPS DMM § 201.3, “Physical Standards for Machinable and Automation Letters and Cards,” and the USPS DMM § 201.3.12, “Flexibility Standards for Automation Letters.” In particular, the assembly is configurable with a length that is not less than 5 inches and not more than 11.5 inches, a width that is not less than 3.5 inches and not more than 6.125 inches, a thickness that is not less than 0.007 inches and not more than 0.25 inches, a profile that is rectangular with four square corners and parallel opposite sides, an aspect ratio defined as the length divided by the width that is not less than 1.3 and not greater than 2.5, a weight that is not greater than 3.5 ounces (0.2188 pounds), and a flexibility such that the assembly is easily bendable when subjected to a transport belt tension of 40 pounds around an 11 inch diameter drum.

The assembly is thus configurable for uninterrupted processing via mail sorters of a postal service provider, such as the USPS. In particular, the configuration of the assembly as described herein supports processing of the assembly with uninterrupted operation of the mail sorters, e.g., without pausing the operation of the mail sorters and/or without removal of the assembly from the mail sorters for manual processing by a postal service worker.

In some aspects, the techniques described herein relate to an assembly for a mailer, including: a backer shaped to engage in face-sharing contact against a forward interior surface of the mailer and span a length of the forward interior surface between opposing closed side edges of the mailer; and an insert that, when assembled, includes a lower folded edge defining a lower closed end of a pocket shaped to receive an article, a terminating edge defining an upper open end of the pocket, and a plurality of attachment members defining opposing sides of the pocket, where the pocket is shaped to engage in face-sharing contact against a rearward surface of the backer opposite to the forward interior surface and the insert spans a length of the rearward surface equal to the length of the forward interior surface spanned by the backer.

In some aspects, the techniques described herein relate to an assembly, wherein the backer has a first thickness, and the insert has a second thickness that is different from the first thickness.

In some aspects, the techniques described herein relate to an assembly, wherein a rigidity of the backer is more rigid than a rigidity of the insert.

In some aspects, the techniques described herein relate to an assembly, wherein the backer and the insert are formed together as a single unit.

In some aspects, the techniques described herein relate to an assembly, wherein, while assembled, a combined thickness of the insert, the backer, and the mailer is less than 0.25 inches to support uninterrupted operation of mail sorters while the assembly is processed by the mail sorters.

In some aspects, the techniques described herein relate to an assembly, wherein an exterior length of the mailer is between 5 inches and 11.5 inches, and a ratio of the length of the forward interior surface to a width of the forward interior surface is between 1.3 and 2.5, where the width is perpendicular to the length.

In some aspects, the techniques described herein relate to an assembly, wherein the article is a trading card.

In some aspects, the techniques described herein relate to an assembly, wherein the pocket is a first pocket and the lower folded edge of the insert further defines a lower closed end of a second pocket shaped to receive a second article, the terminating edge further defines an upper open end of the second pocket, and the plurality of attachment members further define opposing sides of the second pocket.

In some aspects, the techniques described herein relate to an assembly, wherein the second pocket is arranged adjacent to the first pocket, with a first side of the opposing sides of the first pocket defined by a first attachment member of the plurality of attachment members, and with a second side of the opposing sides of the first pocket and a first side of the opposing sides of the second pocket each defined by a second attachment member of the plurality of attachment members with no other attachment members of the plurality of attachment members arranged between the first attachment member and the second attachment member.

In some aspects, the techniques described herein relate to an assembly, wherein the lower folded edge of the insert further defines a lower closed end of a third pocket shaped to receive a third article, the terminating edge further defines an upper open end of the third pocket, and the plurality of attachment members further define opposing sides of the third pocket.

In some aspects, the techniques described herein relate to an assembly, further including a spacer shaped to engage in face-sharing contact with a rearward surface of the insert opposite to the pocket.

In some aspects, the techniques described herein relate to an insert for a mailer, including: a first side flap; a second side flap arranged opposite to the first side flap across the insert; a first set of attachment members including a first attachment member arranged at an exterior surface of the first side flap and a second attachment member arranged at an exterior surface of the second side flap; and a second set of attachment members arranged between the first side flap and the second side flap, the second set of attachment members defining a set of pockets while the first side flap and the second side flap are joined to a panel of the insert via the first set of attachment members.

In some aspects, the techniques described herein relate to an insert, wherein each pocket of the set of pockets includes a respective lower end closed by a folded edge of the panel and a respective open end defined by a terminal edge of the panel.

In some aspects, the techniques described herein relate to an insert, wherein the second set of attachment members is arranged at an interior surface of the insert, and the first side flap and the second side flap overlap the interior surface while joined to the panel.

In some aspects, the techniques described herein relate to an insert, wherein, while joined to the first side flap and the second side flap via the first set of attachment members, the panel joins to the interior surface via the second set of attachment members.

In some aspects, the techniques described herein relate to an insert, wherein a thickness of the insert while the panel is joined to the first side flap, the second side flap, and the interior surface is less than 0.25 inches, a length of the insert from a folded edge of the first side flap to a folded edge of the second side flap is 9.5 inches or less, and a ratio of the length to a width of the insert is 1.4.

In some aspects, the techniques described herein relate to a method for an assembly for a mailer, including: folding a first side flap and a second side flap of an insert to overlap a surface of the insert including a first attachment member and a second attachment member; folding a panel of the insert to overlap the folded first side flap and the folded second side flap; and joining the first attachment member and the second attachment member to the panel to define a set of pockets of the insert.

In some aspects, the techniques described herein relate to a method, further including joining a third attachment member arranged at the first side flap and a fourth attachment member arranged at the second side flap to the panel.

In some aspects, the techniques described herein relate to a method, further including assembling the assembly by arranging the insert with the first attachment member and the second attachment member joined to the panel between a backer and a spacer, where the backer and the spacer each have a respective thickness greater than a thickness of the insert.

In some aspects, the techniques described herein relate to a method, further including seating a plurality of articles within the pockets of the set of pockets of the insert, and inserting the assembly into the mailer while maintaining the plurality of articles within the pockets.

The examples in the figures are shown including features positioned relative to each other. If such features are shown directly contacting each other or adjacent to each other, then the features may be referred to herein as directly contacting or adjacent, respectively. Further, in the figures, features are shown spaced apart from other features, arranged to a left or right side of other features, arranged above or below other features, and so forth, and may be described as such. A “top” of a feature refers to an uppermost portion of the feature and “bottom” of a feature refers to a lowermost portion of the feature. Features shown in the drawings with particular profiles or shapes such as rounded edges, tapering, flatness, concavity, bulging, and so forth may be referred to as such. Features disposed or arranged within other features may be referred to as such, e.g., interior or inner features arranged within exterior or outer features.

In the following discussion, an exemplary environment is first described that may employ the techniques described herein. Examples of implementation details and procedures are then described which may be performed in the exemplary environment as well as other environments. Performance of the exemplary procedures is not limited to the exemplary environment and the exemplary environment is not limited to performance of the exemplary procedures.

### Example of an Environment

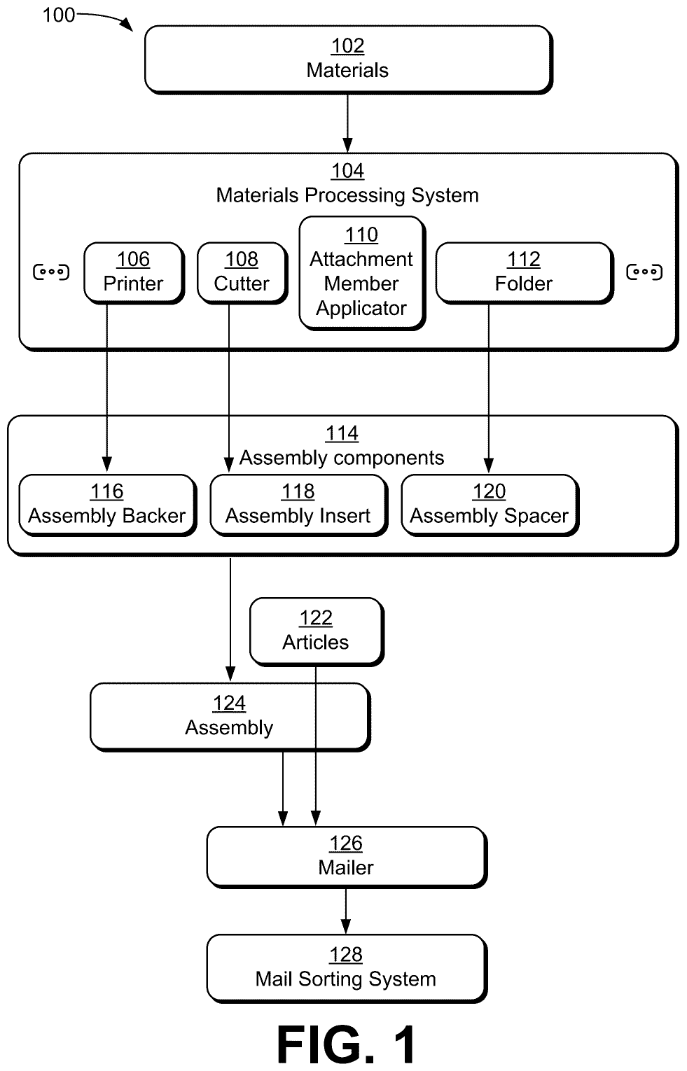

FIG. 1 is an illustration of an environment 100 in an example implementation that is operable to employ techniques described herein. The environment 100 includes example materials 102 and example materials processing system 104 used to form an assembly 124 for a mailer 126 in accordance with the embodiments and examples described herein. The environment 100 additionally includes a mail sorting system 128 configured to receive the assembly 124 via mailer 126. In some instances, the mail sorting system 128 includes mail processing equipment such as automatic processing equipment utilized by the USPS for automatic mail sorting.

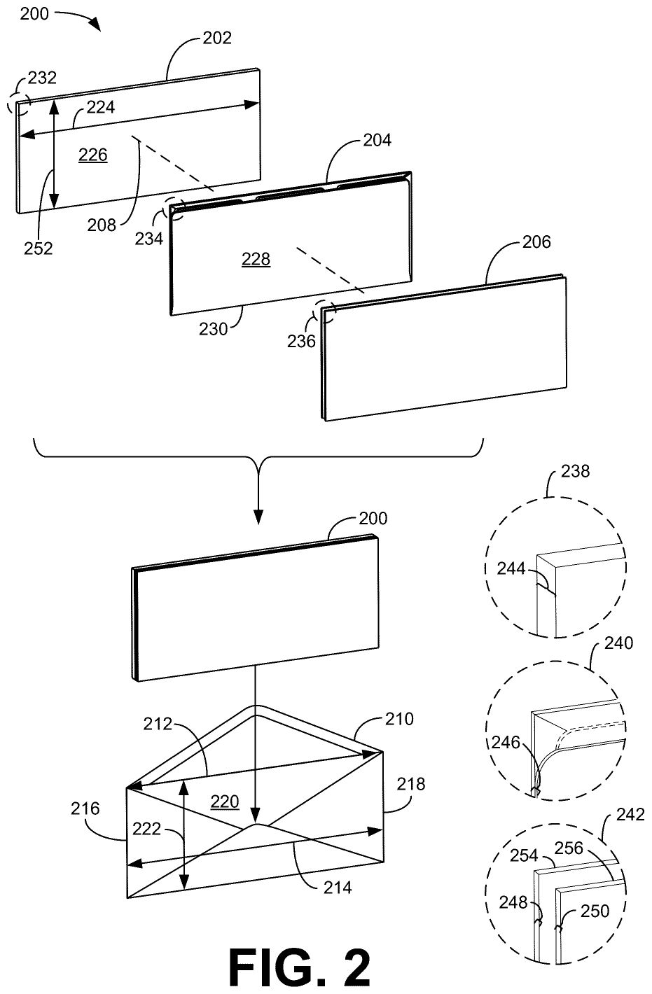

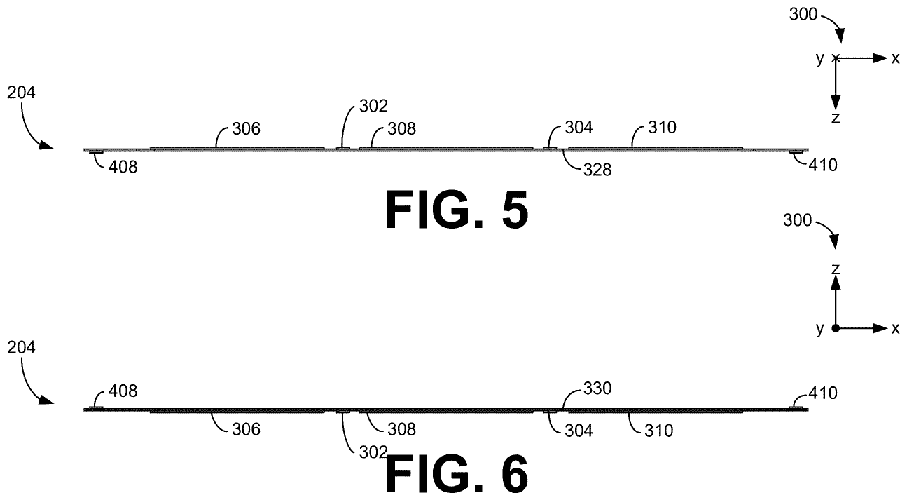

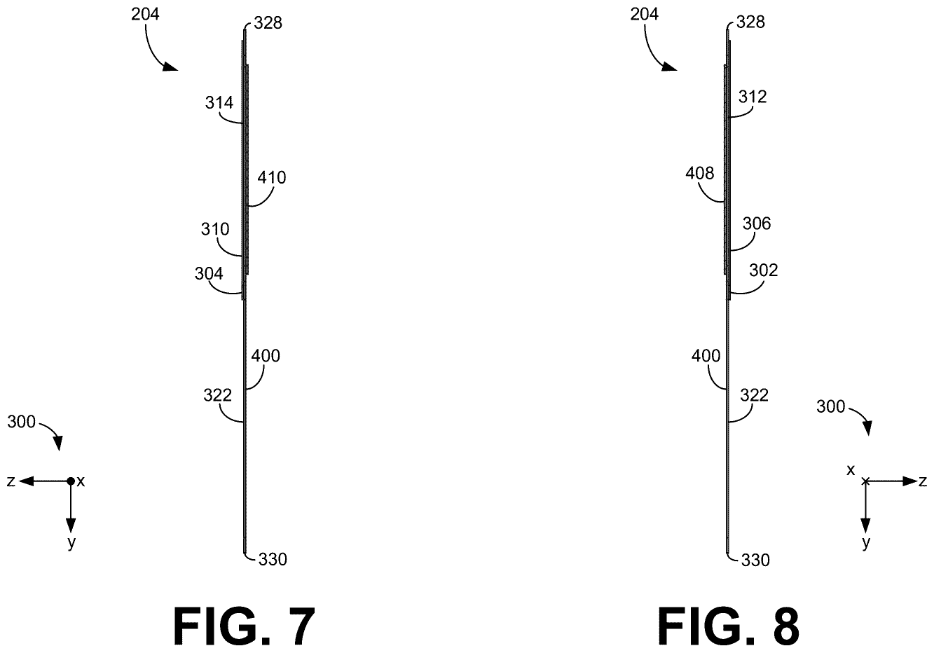

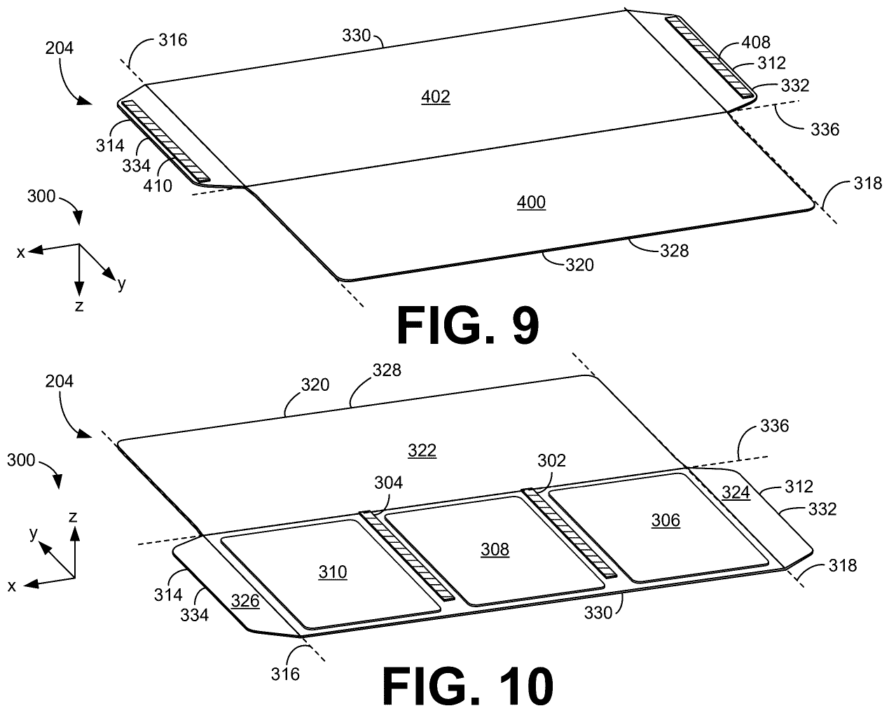

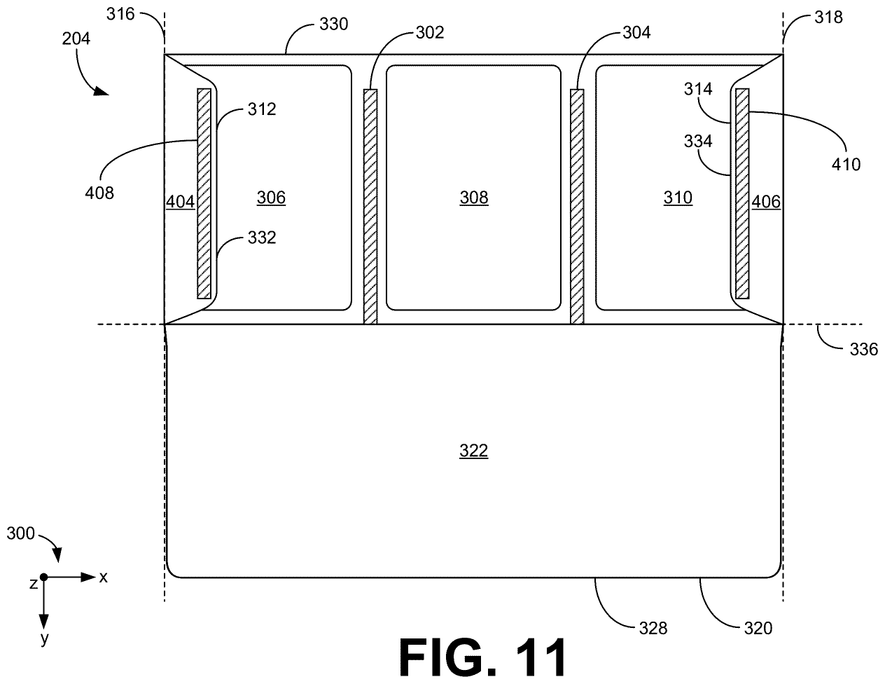

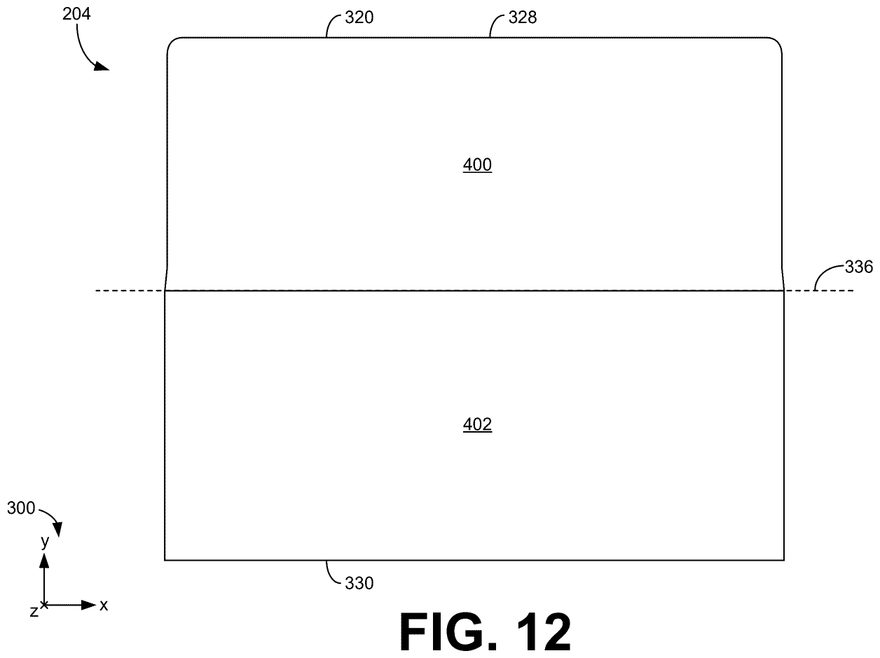

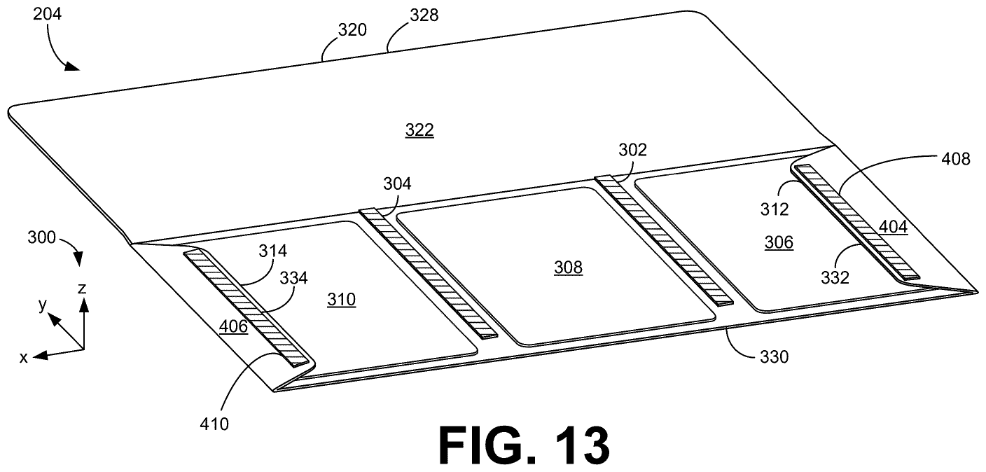

In the example shown, materials 102 are provided to materials processing system 104 for manufacturing or production of assembly components 114. The assembly components 114 include an assembly insert 118. Example inserts similar to, or the same as, assembly insert 118 are described further below with reference to FIGS. 2-20. In the example shown, the assembly components 114 further include an assembly backer 116 and an assembly spacer 120. However, in some instances, the assembly 124 includes the assembly insert 118 and does not include the assembly backer 116 and/or the assembly spacer 120.

The materials 102 in some instances include materials with different properties such as different weights, thicknesses, rigidities, compositions (e.g., fiber content), and so forth. For example, materials 102 in some instances include a first material having a first weight, thickness, and/or composition from which assembly insert 118 is formed, and materials 102 additionally include a second material having a second weight, thickness, and/or composition from which assembly backer 116 is formed. The first material and the second material are each paper materials, in some instances. The assembly backer 116 is configured to have a higher rigidity than the assembly insert 118, and in some instances the material forming the assembly backer 116 is thicker than the material forming the assembly insert 118. The assembly spacer 120 in some instances is formed from the same material as the assembly insert 118 but is separate from the assembly insert 118, e.g., not formed as a single unit integrated with the assembly insert 118. However, in some instances the materials 102 include a third material having a third weight, thickness, and/or composition, and the assembly spacer 120 is formed from the third material. The third material is a paper material, in some instances.

In some instances, a composition of the first material is different than a composition of the second material and/or a composition of the third material. In one example, the first material is a paper material with a composition including greater than 50% cellulose fiber content by weight, and second material is a paper material with a composition including greater than 75% cellulose fiber content by weight. Other examples are possible. The materials are thus configurable with different rigidities according to their thickness and/or composition. As one example, the first material is configurable with a first rigidity based on the composition and/or thickness of the first material, and the second material is configurable with a second rigidity based on the composition and/or thickness of the second material. The second rigidity is greater than the first rigidity, in some instances, such that the second material is more resistant to bending and deformation compared to the first material. In some instances, the second material is at least twice as rigid as the first material.

The materials 102 are provided to the materials processing system 104 for production of the assembly components 114. In the example shown, the materials processing system 104 includes various production equipment such as a printer 106, cutter 108, attachment member applicator 110, and folder 112. However, in some instances, materials processing system 104 includes additional equipment, such as an embosser, foil applicator, and so forth, in accordance with manufacturer preferences.

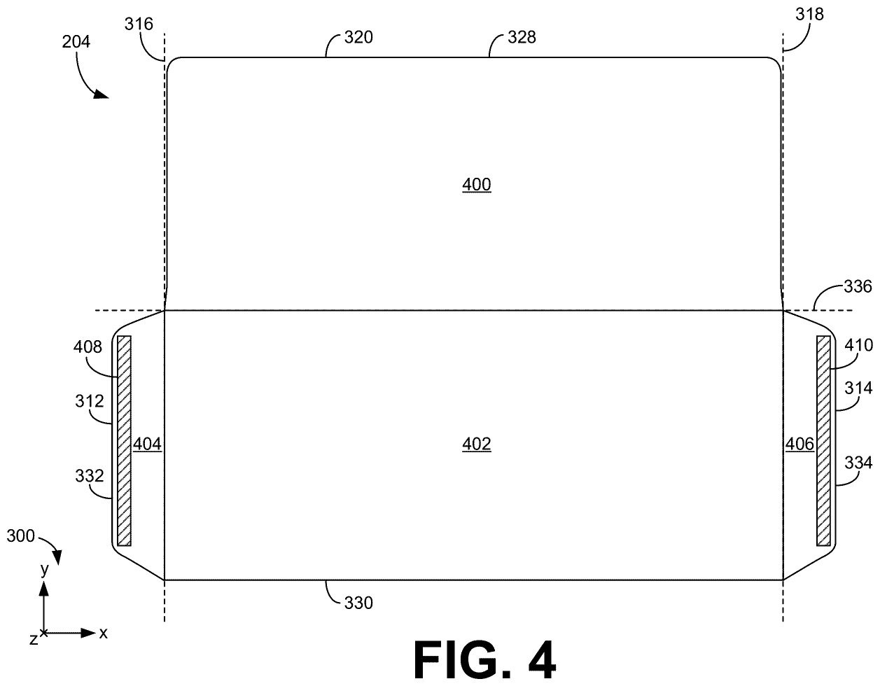

In an example operation, a paper material included by materials 102 is provided to printer 106, and printer 106 processes the paper material by printing an image to the paper material. The printed paper material is then provided to cutter 108, with the cutter 108 cutting the paper material to form a flattened paper form, similar to the example shown by FIG. 4 and described below. The flattened paper form is provided to attachment member applicator 110, and the attachment member applicator 110 applies attachment members to the flattened paper form in accordance with the examples described herein.

The attachment members are configurable as various types of attachment members such as adhesive strips, mechanical fasteners such as staples, brads, or rivets, or other types of attachment members. In some instances, the attachment members are formed by the materials themselves. In an example, the attachment member applicator 110 employs stamping or embossing of the materials together to secure the surfaces of the materials to each other. As another example, the attachment member applicator 110 employs perforation of one or more surfaces of the materials to form interlocking openings and protrusions formed by the materials themselves, and the interlocking of the openings and protrusions secures, e.g., attaches, the surfaces to each other.

The flattened paper form with attachment members is provided to the folder 112, with the folder 112 folding the flattened paper form along fold axes to form the assembly insert 118. In folding the flattened paper form, the folder 112 presses surfaces of the flattened paper form against the attachment members, thereby attaching the surfaces to each other via the attachment members. The attachment members maintain the shape of the resulting assembly insert 118.

Although the operation described above is provided as one example of forming assembly insert 118 from materials 102 via the materials processing system 104, it should be noted that in some instances the assembly insert 118 is formable via a different sequence of operations performed by the materials processing system 104 or different equipment included by the materials processing system 104. For example, in some instances, the processing of the materials 102 via materials processing system 104 supports providing the flattened paper form to the folder 112 for folding, and then providing the folded paper form to the attachment member applicator 110 for application of the attachment members to the folded paper form. In another example, in some instances, the processing of the materials 102 via the materials processing system 104 supports a different order of processing of the materials 102, such as providing the materials 102 to folder 112 for cutting, then providing the folded materials to printer 106 for printing, then providing the folded and printed materials to cutter 108 for cutting, and then providing the folded, printed, and cut materials to attachment member applicator 110 for application of the attachment members to the materials. Other examples are possible.

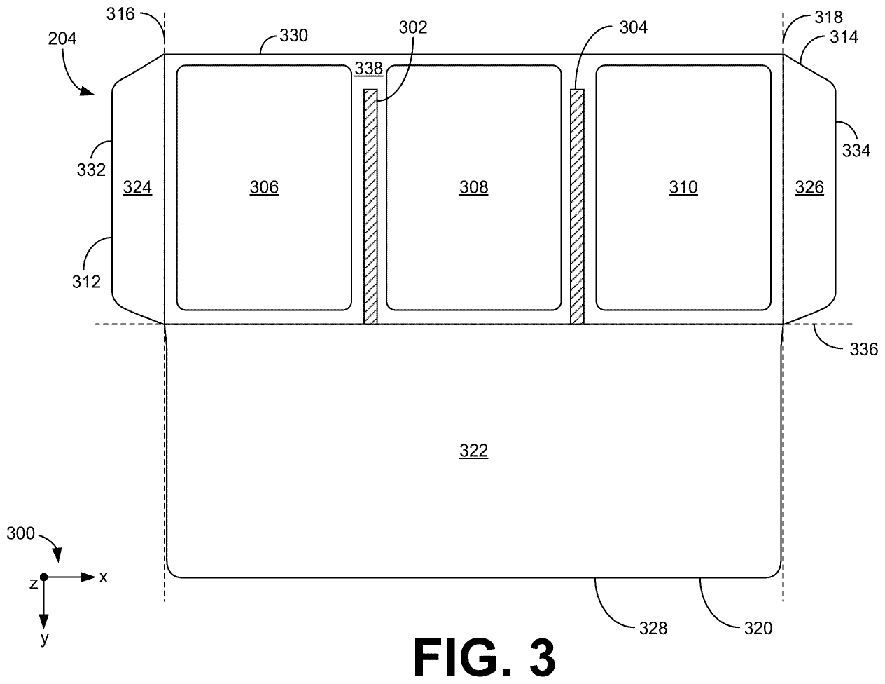

The assembly components 114 are assembled together to form the assembly 124. The assembling of the assembly components 114 is similar to, or the same as, the assembling operations described below with reference to FIG. 3 in some instances.

The environment 100 additionally depicts articles 122. In the example shown, articles 122 are supported within the assembly 124, and the assembly 124 is inserted into mailer 126. In some instances, articles 122 are playing cards and/or collectible trading cards, and the articles 122 are inserted into pockets formed by the assembly insert 118. The assembly insert 118, the assembly backer 116, and the assembly spacer 120, referred to herein collectively as the assembly 124, are inserted into the mailer 126 with the articles 122 seated within the assembly insert 118. In some instances, the mailer 126 is an envelope in compliance with USPS standards for machinable letters and cards, as described above. For example, in some instances the mailer 126 is a #10 envelope.

The mailer 126, with the assembly 124 disposed therein and the articles 122 supported within the assembly 124 by the pockets of the assembly insert 118, is provided to mail sorting system 128 for delivery to a recipient, e.g., a customer. By configuring the assembly 124 according to the examples described herein, mail sorting system 128 processes the mailer 126 including the assembly 124 with a reduced likelihood of degradation of the mailer 126 and assembly 124, as described above.

Having considered an example of an environment, consider now a discussion of some example details of the assembly for a mailer with one or more implementations.

### Assembly for a Mailer

FIG. 2 depicts an example assembly 200 for a mailer 210 in accordance with the configurations described herein. The assembly 200 shown in the example includes a backer 202, an insert 204, and a spacer 206. The backer 202, insert 204, and spacer 206 are assembled together along an assembly axis 208. For instance, the backer 202 and spacer 206 are arranged at opposing sides of the insert 204, such that the insert 204 is between the backer 202 and the spacer 206 during conditions in which the assembly 200 is inserted into the mailer 210. Although the backer 202 is shown arranged toward the rear end of the mailer 210 in the example, in some instances the backer 202 is arranged toward the front end of the mailer 210 and the spacer 206 is arranged toward the rear end of the mailer 210. The front end of the mailer 210 refers to an address end of the mailer 210, e.g., the end of the mailer 210 at which the address of the sender and recipient is shown, and the rear end refers to the end opposite to the address end.

In the example of FIG. 2, the mailer 210 is shown with a forward interior surface 220 having a length 212 and a width 222, where the width 222 is perpendicular to the length 212. The forward interior surface 220 is a surface within an interior of the mailer 210 and engages directly in face-sharing contact with one or more surfaces of the components of the assembly 200. Face-sharing contact refers to direct contact of the surfaces, with no other components arranged between the contacting surfaces. For instance, in the configuration of the assembly 200 shown by FIG. 2 in which the assembly 200 includes backer 202, a forward surface of the backer 202, opposite to a rearward surface 226 of the backer 202, is shaped to directly contact the forward interior surface 220 of the mailer 210.

The rearward surface 226 of the backer 202 is in direct contact with the insert 204 during conditions in which the assembly 200 is arranged within the mailer 210, and the backer 202 separates the insert 204 from the forward interior surface 220 of the mailer 210, e.g., spaces apart the insert 204 from the forward interior surface 220. The length 224 of the backer 202 is configurable as slightly smaller than the length 212 of the forward interior surface 220 of the mailer 210, e.g., between 95-99% of the length 212 of the forward interior surface 220. In some instances, the length 224 is less than 9.5 inches. The length 224 of the backer 202 substantially spans the length 212 of the forward interior surface 220 of the mailer 210. Similarly, a width 252 of the backer 202 is configurable as slightly smaller than the width 222 of the forward interior surface 220, e.g., between 95-99% of the width 222 of the forward interior surface 220. The forward interior surface 220 of the mailer 210 is bounded by, and defined by, each of a first closed side 216 and a second closed side 218 of the mailer 210. The first closed side 216 and the second closed side 218 may each be folded edges of the mailer 210, in some instances. An exterior length 214 of the mailer 210 is configured to be slightly larger than the interior length 212, and a difference between the interior length 212 and the exterior length 214 results from a thickness of a material forming the mailer 210, in some instances.

During conditions in which the assembly 200 is assembled along the assembly axis 208, the rearward surface 226 of the backer 202 directly contacts the insert 204, and a rearward surface 228 of the insert 204 directly contacts the spacer 206. A resulting thickness of the assembly 200, once assembled, is less than 0.25 inches, in some instances. The thickness of the assembly 200 results from a combination of a thickness 244 of the backer 202 shown by enlargement 238 of encircled portion 232 of the backer 202, a thickness 246 of the insert 204 shown by enlargement 240 of encircled portion 234, and a thickness of each of the sheets included by the spacer 206. In the example shown, the spacer 206 includes a first sheet 254 with a thickness 248 and a second sheet 256 with a thickness 250, as shown by enlargement 242 of encircled portion 236. However, the spacer 206 is configurable to include a different number of sheets, and the sheets are folded in some examples which results in an increased overall thickness of the spacer 206. In at least some implementations, the thickness 244 of the backer 202 is larger than the thickness 246 of the insert 204. Further, in some implementations, the overall thickness of the spacer 206 resulting from the individual thicknesses of the sheets included by the spacer 206 is larger than the thickness 246 of the insert 204.

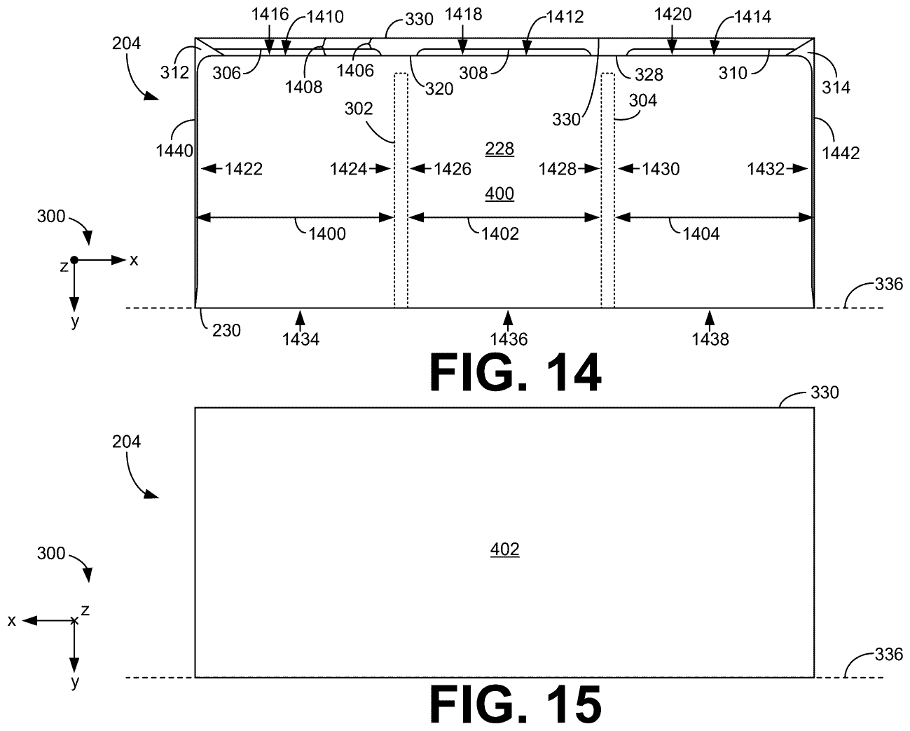

Referring collectively to FIGS. 3-16, various views of the insert 204 are shown. In particular, FIGS. 3-10 each show the insert 204 in an unfolded configuration, FIGS. 11-13 show the insert 204 in a partially folded configuration, and FIGS. 14-16 show the insert 204 in a fully folded configuration. Reference axes 300 are included by each of the views for ease of comparison.

In the view shown by FIG. 3, the insert 204 is shown in the unfolded configuration with three articles to be supported within pockets of the insert 204 shown in broken lines. In particular, article 306, article 308, and article 310 are shown. In some instances, each of the articles is a collectible trading card with dimensions equal to 2.5 inches in the direction of the x-axis of reference axes 300 and 3.5 inches in the direction of the y-axis of reference axes 300. The articles are spaced apart evenly from each other and are separated by attachment members indicated with oblique hatch shading. In particular, article 306 is spaced apart from article 308 by attachment member 302 of insert 204, and article 308 is spaced apart from article 310 by attachment member 304 of insert 204. The attachment member 302 and the attachment member 304 define pockets of the insert 204. The attachment members may be various different types of attachment members such as adhesive strips, mechanical fasteners such as staples, brads, or rivets, features of the material forming the insert 204 that interlock to attach the surfaces of the insert 204 to each other such as interlocking perforations, and so forth.

Referring momentarily to FIG. 14, the insert 204 is shown in the fully folded configuration. In the view shown, the attachment member 302 and the attachment member 304 are each shown in broken lines to indicate that the attachment member 302 and the attachment member 304 are arranged behind the rearward surface 228 of the insert 204 relative to the plane of view. In the fully folded configuration, a first pocket 1410 includes a first side 1422 defined by a first folded side edge 1440 of the insert 204 and a second side 1424 defined by the attachment member 302. A second pocket 1412 includes a first side 1426 defined by the attachment member 302 and a second side 1428 defined by the attachment member 304. A third pocket 1414 includes a first side 1430 defined by the attachment member 304 and a second side 1432 defined by a second folded side edge 1442 of the insert 204, opposite to the first folded side edge 1440. The first pocket 1410 has a length 1400, the second pocket 1412 has a length 1402, and the third pocket 1414 has a length 1404. In some instances, each of the length 1400, the length 1402, and the length 1404 is equal to approximately 2.5 inches.

The first pocket 1410 is further defined by a lower closed end 1434 and an upper open end 1416. The second pocket 1412 is further defined by a lower closed end 1436 and an upper open end 1418, and the third pocket 1414 is further defined by a lower closed end 1438 and an upper open end 1420. A terminating edge 328 of the rearward surface 228 of the insert 204 forms each of the upper open end 1416, the upper open end 1418, and the upper open end 1420. The rearward surface 228 is also referred to herein as an exterior surface 400 of the insert 204. A lower folded edge 230 of the insert 204 forms each of the lower closed end 1434, the lower closed end 1436, and the lower closed end 1438. Although in the example shown the insert 204 includes three pockets, in some instances the insert 204 is configurable with a different number of pockets, such as a single pocket or two pockets. In such instances, at least some of the edges or sides of the pockets are defined by attachment members similar to the attachment member 302 and/or the attachment member 304.

In this configuration, the second pocket 1412 is arranged between the first pocket 1410 and the third pocket 1414 in the direction of the x-axis of reference axes 300. The article 306 is shown seated within the first pocket 1410, the article 308 is shown seated within the second pocket 1412, and the article 310 is shown seated within the third pocket 1414. In the fully folded configuration of the insert 204, the terminating edge 328 is spaced apart in the direction of the y-axis of the reference axes 300 from another terminating edge 330 of the insert 204 by clearance 1408 shown by FIG. 14, where the terminating edge 330 is arranged behind the terminating edge 328 relative to the plane of view of FIG. 14. In this arrangement, a portion of each of the articles is visible between the terminating edge 330 and the terminating edge 328, which increases an ease of inserting and removing the articles from the pockets and an ease of identification of the articles, e.g., by a recipient of the assembly 200. Further, each of the articles is offset from terminating edge 330 by clearance 1406. The first pocket 1410, the second pocket 1412, and the third pocket 1414 may be referred to herein collectively as a set of pockets. Further, attachment member 408 and attachment member 410 may be referred to herein collectively as a set of attachment members, e.g., a first set of attachment members, and the attachment member 302 and the attachment member 304 may be referred to herein collectively as a set of attachment members, e.g., a second set of attachment members.

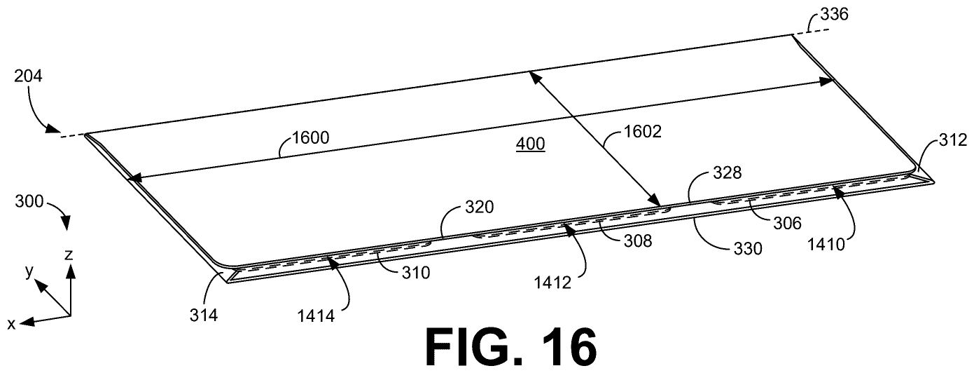

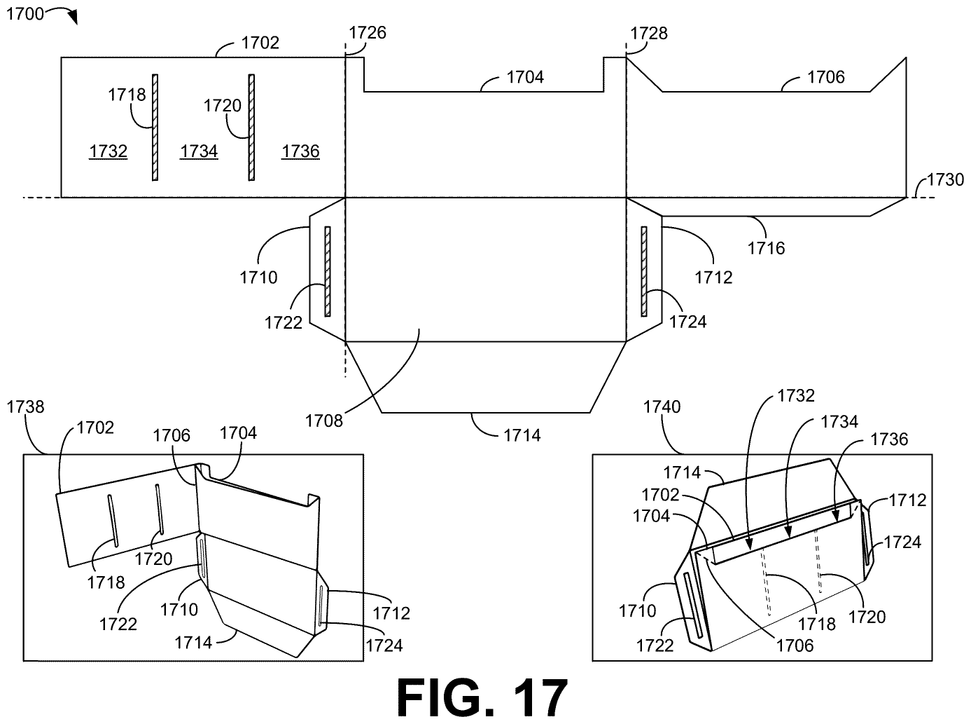

In a method of transitioning the insert 204 from the unfolded configuration shown by FIG. 3 to the fully folded configuration shown by FIG. 14, various portions of the insert 204 are folded, e.g., via a folder such as folder 112 shown by FIG. 1. Once folded, at least some of the portions are joined, e.g., connected or interlocked, to each other via the attachment members described herein. Further, in the fully folded configuration, a length 1600 of the insert 204 is less than 9.5 inches in some instances, and a width 1602 is less than 4.125 inches in some instances, with the length 1600 and width 1602 indicated in FIG. 16. A ratio of the length 1600 to the width 1602 is 1.4, in some instances, and the length 1600 is perpendicular to the width 1602. A shape or profile of the insert in the fully folded configuration is rectangular, with four square corners and parallel opposing sides.

In the view shown by FIG. 3, the insert 204 is shown to include a panel 320 defining an interior surface 322 and the terminating edge 328. The insert 204 further includes a side flap 312 defining a terminating edge 332 and an interior surface 324, and a side flap 314 defining a terminating edge 334 and an interior surface 326. The side flap 312 is arranged opposite to the side flap 314 across the insert 204 in a direction of the x-axis of reference axes 300.

While FIG. 3 shows a view of the insert 204 in a first orientation, FIG. 4 shows a view of the insert 204 in the opposite orientation, e.g., flipped relative to the orientation shown by FIG. 3 as indicated by reference axes 300. In the view shown by FIG. 4, attachment member 408 is shown joined, e.g., secured, to an exterior surface 404 of the side flap 312, and attachment member 410 is shown secured to an exterior surface 406 of the side flap 314. Further, FIG. 4 depicts exterior surface 402 opposite to interior surface 338 depicted by FIG. 3, and exterior surface 400 opposite to interior surface 322 depicted by FIG. 3.

In transitioning the insert 204 from the unfolded configuration to the fully folded configuration, the side flap 312 is folded along fold axis 316 in a direction toward the interior surface 338 shown by FIG. 3 to overlap the interior surface 338. Additionally, the side flap 314 is folded along fold axis 318 in a direction toward the interior surface 338 to overlap the interior surface 338. Following the folding of the side flap 312 and the side flap 314, the insert 204 is in a partially folded configuration, as depicted by FIGS. 11-13.

The insert 204 is transitioned from the partially folded configuration to the fully folded configuration by folding the panel 320 along fold axis 336 in a direction toward the interior surface 338 to overlap the folded side flap 312 and the folded side flap 314. As the panel 320 is folded along the fold axis 336, the interior surface 322 of the panel 320 comes into direct face-sharing contact with the attachment member 408 arranged at the exterior surface 404 of the side flap 312 and the attachment member 410 arranged at the exterior surface 406 of the side flap 314. The attachment member 408 and the attachment member 410 each join to the interior surface 322 of the panel 320 and secure the panel 320 to the folded side flap 312 and the folded side flap 314. As a result, the pockets of the insert 204 are formed between the interior surface 338 and the interior surface 322.

Thus, in the configuration described above, the insert 204 is formed as a single sheet of material, e.g., a paper material, with pockets of the insert 204 defined at least in part by the attachment member 302 and the attachment member 304 without additional sheets or other components coupled to the insert 204. The pockets of the insert 204 secure the articles for mailing within the mailer 210 while providing for a reduced weight of the assembly 200 relative to conventional approaches that utilize molded, cast, or extruded sleeves formed from materials such as plastic or metal. Additionally, the insert 204 reduces a likelihood of occurrence of ridges or other protrusions at exterior surfaces of the mailer 210. The backer 202 and spacer 206 further increase a flatness and rigidity of the assembly 200 while supporting flexibility of the assembly 200 for processing via automation equipment such as automatic mail sorters utilizing belts and/or rollers. As a result, a likelihood of degradation of the assembly 200 and mailer 210 is reduced, which reduces costs associated with replacement of the articles and/or costs associated with undesired manual sorting of the mailer 210.

In some instances, the transition of the insert 204 from the unfolded configuration to the fully folded configuration includes a different order of folding and/or the application of one or more of the attachment members during the transition, in accordance with the examples described above with reference to FIG. 1. For example, in some instances, the transition includes folding one or more portions of the insert 204 as described above and applying the attachment members to join the surfaces of the insert to each other after the insert 204 has been at least partially folded. As one example, in some instances the transition includes folding the panel 320 along the fold axis 336 as described above, and applying the attachment member 302 and the attachment member 304 between the panel 320 and the interior surface 338 to join the panel 320 to the interior surface 338. In the example, the attachment members are configurable as staples, brads, rivets, or other types of fasteners that extend between the panel 320 and the interior surface 338. The attachment members in the example are also configurable as interlocking features formed by the material of the insert 204 itself, such as interlocking perforations and protrusions, at least in some instances.

In some configurations, such as the configurations described below with reference to FIGS. 17-20, the insert of the mailer includes additional panels, flaps, and/or other features that provide the insert with increased rigidity and flatness. In such configurations, the additional panels and other features are employed to provide an integrated backer for the insert. In particular, in the configurations described below, the insert and backer are integrated together, e.g., formed together as a single unit from a same material. Thus, in the following discussion of the examples shown by FIGS. 17-20, some panels are referred to as backers, with the panels and the other features of the inserts formed from a single sheet of material. The inserts shown by FIGS. 17-20, when fully folded, include characteristics similar to those described above for compliance with automation equipment such as automatic mail sorters. For example, in some instances, each insert in the fully folded configuration is shaped to fit within a #10 envelope with dimensions equal to 9.5 inches in length and 4.125 inches in width. Further, each insert is configured with a thickness less than 0.25 inches in some instances, and so forth, in accordance with the USPS DMM standards as described above.

Referring to FIG. 17, another example insert 1700 is shown. The insert 1700 includes panel 1702, panel 1704, panel 1706, and panel 1708 formed together as a single unit. The panels provide reinforcement of the insert 1700, with panel 1704 forming an integrated backer of the insert 1700, for instance. The panel 1702 includes attachment member 1718 and attachment member 1720. The attachment member 1718 and the attachment member 1720 each define boundaries of pockets of the insert 1700, with attachment member 1718 defining a boundary of a first pocket 1732, attachment member 1718 and attachment member 1720 each defining opposing boundaries of a second pocket 1734, and with attachment member 1720 further defining a boundary of a third pocket 1736. The first pocket 1732, second pocket 1734, and third pocket 1736 are formed between the panel 1702 and the panel 1708 during conditions in which the insert 1700 is fully folded.

In transitioning the insert 1700 from the unfolded configuration shown by FIG. 17 to the fully folded configuration, an end flap 1716 of the panel 1706 is folded along fold axis 1730 in a direction toward the plane of view of FIG. 17. The end flap 1716 and panel 1706 are together folded along fold axis 1728 in a direction toward panel 1704 and toward the plane of view. The panel 1702 is folded toward the panel 1704 and the folded panel 1706, along fold axis 1726 and toward the plane of view. Inset 1738 illustrates the insert 1700 in a partially folded configuration in which the panel 1706 is folded toward panel 1704, and the panel 1702 is partially folded toward the panel 1704 and the folded panel 1706.

Following the folding of the panel 1702 as described above, panel 1708 is folded along fold axis 1730 toward the folded panel 1702 and away from the plane of view, as illustrated by inset 1740. In the inset 1740, the features illustrated in broken lines are hidden behind other features relative to the plane of view. A side flap 1710 and a side flap 1712 are each connected to the panel 1708 and are each folded toward the folded panel 1702. Further, an end flap 1714 connected to the panel 1708 is folded toward the folded panel 1702, and attachment member 1722 and attachment member 1724 each secure the position of the panel 1708 relative to the panel 1704. The first pocket 1732, the second pocket 1734, and the third pocket 1736 may be referred to herein collectively as a set of pockets. Further, attachment member 1722 and attachment member 1724 may be referred to herein collectively as a set of attachment members, e.g., a first set of attachment members, and the attachment member 1718 and the attachment member 1720 may be referred to herein collectively as a set of attachment members, e.g., a second set of attachment members. The various panels thus increase the rigidity and flatness of the insert 1700 without the addition of components separate from the insert 1700.

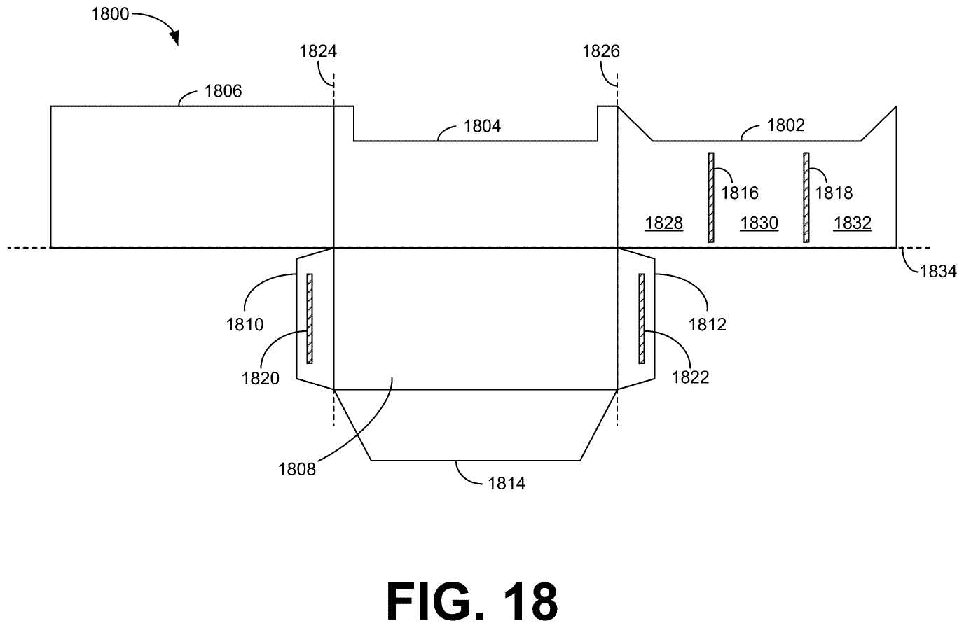

Another example insert 1800 is shown by FIG. 18. The insert 1800 includes panel 1802, panel 1804, panel 1806, and panel 1808 formed together as a single unit, e.g., formed from a single uninterrupted sheet of material. The panels provide reinforcement of the insert 1800, with panel 1804 forming an integrated backer of the insert 1800, for instance. The panel 1802 includes attachment member 1816 and attachment member 1818. The attachment member 1816 and the attachment member 1818 each define boundaries of pockets of the insert 1800, with attachment member 1816 defining a boundary of a first pocket 1828, attachment member 1816 and attachment member 1818 each defining opposing boundaries of a second pocket 1830, and with attachment member 1818 further defining a boundary of a third pocket 1832. The first pocket 1828, second pocket 1830, and third pocket 1832 are formed between the panel 1802 and the folded panel 1806 during conditions in which the insert 1800 is fully folded.

In transitioning the insert 1800 from the unfolded configuration shown by FIG. 18 to the fully folded configuration, the panel 1806 is folded along fold axis 1824 in a direction toward panel 1804, toward the plane of view of FIG. 18. The panel 1802 is folded toward the folded panel 1806 and the panel 1804 along fold axis 1826, toward the plane of view. The panel 1808 is folded toward the folded panel 1802 and the folded panel 1806 along fold axis 1834, toward the plane of view. A side flap 1810 connected to the panel 1808 is folded toward the panel 1804, and another side flap 1812 connected to the panel 1808 is folded toward the panel 1804. Attachment member 1820 and attachment member 1822 each secure the position of the panel 1808 relative to the panel 1804. Further, end flap 1814 is folded toward the panel 1804. The first pocket 1828, the second pocket 1830, and the third pocket 1832 may be referred to herein collectively as a set of pockets. Further, attachment member 1820 and attachment member 1822 may be referred to herein collectively as a set of attachment members, e.g., a first set of attachment members, and the attachment member 1816 and the attachment member 1818 may be referred to herein collectively as a set of attachment members, e.g., a second set of attachment members. The various panels thus increase the rigidity and flatness of the insert 1800 without the addition of components separate from the insert 1800.

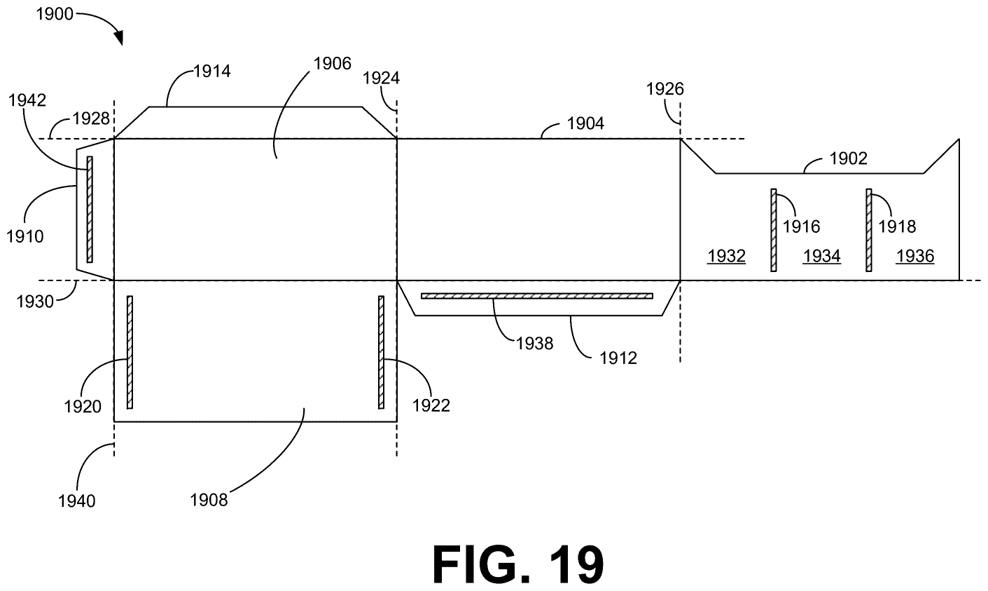

Another example insert 1900 is shown by FIG. 19. The insert 1900 includes panel 1902, panel 1904, panel 1906, and panel 1908 formed together as a single unit. The panels provide reinforcement of the insert 1900, with panel 1906 forming an integrated backer of the insert 1900, for instance. The panel 1902 includes attachment member 1916 and attachment member 1918. The attachment member 1916 and the attachment member 1918 each define at least a portion of pockets of the insert 1900, with attachment member 1916 defining a boundary of a first pocket 1932, attachment member 1916 and attachment member 1918 each defining opposing boundaries of a second pocket 1934, and with attachment member 1918 further defining a boundary of a third pocket 1936. The first pocket 1932, second pocket 1934, and third pocket 1936 are formed between the panel 1902 and the panel 1904 during conditions in which the insert 1900 is fully folded.

In transitioning the insert 1900 from the unfolded configuration shown by FIG. 19 to the fully folded configuration, the panel 1902 is folded along fold axis 1926 toward the panel 1904 in a direction toward the plane of view of FIG. 19. An end flap 1912 connected to the panel 1904 is folded along fold axis 1930 against the folded panel 1902, and attachment member 1938 joins the end flap 1912 to the panel 1904. The panel 1904, folded panel 1902, and folded end flap 1912 are folded together along fold axis 1924 toward panel 1906 in a direction toward the plane of view. A side flap 1910 joined to the panel 1906 is folded along fold axis 1940 toward the folded panel 1904 and the folded panel 1902, and attachment member 1942 secures the side flap 1910 to the folded panel 1904. The panel 1908 is folded along fold axis 1930 toward the folded panel 1904 and is secured to the panel 1904 by attachment member 1920 and attachment member 1922. End flap 1914 joined to panel 1906 is folded along fold axis 1928 toward the folded panel 1908. The first pocket 1932, the second pocket 1934, and the third pocket 1936 may be referred to herein collectively as a set of pockets. Further, attachment member 1920, attachment member 1922, attachment member 1938, and attachment member 1942 may be referred to herein collectively as a set of attachment members, e.g., a first set of attachment members, and the attachment member 1916 and the attachment member 1918 may be referred to herein collectively as a set of attachment members, e.g., a second set of attachment members.

By securing (e.g., fixing) the panel 1902 to the panel 1904 via attachment member 1916 and attachment member 1918, the first pocket 1932, second pocket 1934, and third pocket 1936 are defined between the panel 1902 and the panel 1904.

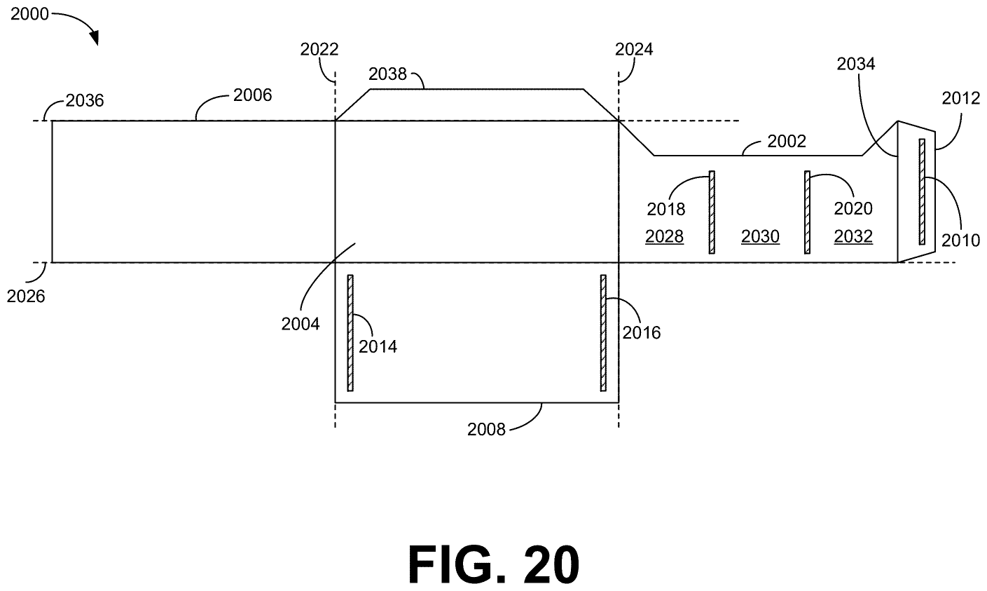

Another example insert 2000 is shown by FIG. 20. The insert 2000 includes panel 2002, panel 2004, panel 2006, and panel 2008 formed together as a single unit. The panels provide reinforcement of the insert 2000, with panel 2004 forming an integrated backer of the insert 2000, for instance. The panel 2002 includes attachment member 2018 and attachment member 2020. The attachment member 2018 and the attachment member 2020 each define at least a portion of pockets of the insert 2000, with attachment member 2018 defining a boundary of a first pocket 2028, attachment member 2018 and attachment member 2020 each defining opposing boundaries of a second pocket 2030, and with attachment member 2020 further defining a boundary of a third pocket 2032. The first pocket 2028, second pocket 2030, and third pocket 2032 are formed between the panel 2002 and the folded panel 2006 during conditions in which the insert 2000 is fully folded.

In transitioning the insert 2000 from the unfolded configuration shown by FIG. 20 to the fully folded configuration, the panel 2006 is folded along fold axis 2022 toward the panel 2004 in a direction toward the plane of view of FIG. 20. The panel 2002 is folded along fold axis 2024 toward the folded panel 2006 and panel 2004. A side flap 2012 joined to the panel 2002 is folded along seam 2034 and is secured to panel 2004 via attachment member 2010. Panel 2008 is folded along fold axis 2026 toward panel 2004 and is secured to the panel 2004 via attachment member 2014 and attachment member 2016. Further, end flap 2038 joined to panel 2004 is folded along fold axis 2036 toward the folded panel 2006 and the folded panel 2002. By securing (e.g., fixing) the panel 2002 to the folded panel 2006 via attachment member 2018 and attachment member 2020, the first pocket 2028, second pocket 2030, and third pocket 2032 are defined between the panel 2002 and the folded panel 2006. The first pocket 2028, the second pocket 2030, and the third pocket 2032 may be referred to herein collectively as a set of pockets. Further, attachment member 2010, attachment member 2014, and attachment member 2016 may be referred to herein collectively as a set of attachment members, e.g., a first set of attachment members, and the attachment member 2018 and the attachment member 2020 may be referred to herein collectively as a set of attachment members, e.g., a second set of attachment members.

The assembly insert configurations described above thus support the mailing of articles, such as trading cards, while providing rigidity and flexibility characteristics compliant with standards for automatic processing of mail via postal service automatic mail sorting equipment. In particular, each of the inserts shown by FIGS. 17-20 includes panels providing the compliant rigidity and flexibility characteristics while being formed from a single sheet of material. The inserts form pockets shaped to support articles such as trading cards between the folded panels, with the pockets defined at least in part by attachment members. By forming each insert from a single sheet of material and folding the panels of the inserts as described above with reference to FIGS. 17-20, production costs of the inserts are reduced in some instances, which reduces a cost of the mailing of the articles. Further, the insert configurations support compliancy with postal service automatic processing equipment, which reduces costs associated with unexpected manual processing.

### CONCLUSION

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. An assembly for a mailer, comprising:
a backer shaped to engage in face-sharing contact against a forward interior surface of the mailer and span a length of the forward interior surface between opposing closed side edges of the mailer; and
an insert that, when assembled, includes a lower folded edge defining a lower closed end of a pocket shaped to receive an article, a terminating edge defining an upper open end of the pocket, and a plurality of attachment members defining opposing sides of the pocket, where the pocket is shaped to engage in face-sharing contact against a rearward surface of the backer opposite to the forward interior surface and the insert spans a length of the rearward surface equal to the length of the forward interior surface spanned by the backer.

2. The assembly of claim 1, wherein the backer has a first thickness, and the insert has a second thickness that is different from the first thickness.

3. The assembly of claim 1, wherein a rigidity of the backer is more rigid than a rigidity of the insert.

4. The assembly of claim 1, wherein the backer and the insert are formed together as a single unit.

5. The assembly of claim 1, wherein, while assembled, a combined thickness of the insert, the backer, and the mailer is less than 0.25 inches to support uninterrupted operation of mail sorters while the assembly is processed by the mail sorters.

6. The assembly of claim 1, wherein an exterior length of the mailer is between 5 inches and 11.5 inches, and a ratio of the length of the forward interior surface to a width of the forward interior surface is between 1.3 and 2.5, where the width is perpendicular to the length.

7. The assembly of claim 1, wherein the article is a trading card.

8. The assembly of claim 1, wherein the pocket is a first pocket and the lower folded edge of the insert further defines a lower closed end of a second pocket shaped to receive a second article, the terminating edge further defines an upper open end of the second pocket, and the plurality of attachment members further define opposing sides of the second pocket.

9. The assembly of claim 8, wherein the second pocket is arranged adjacent to the first pocket, with a first side of the opposing sides of the first pocket defined by a first attachment member of the plurality of attachment members, and with a second side of the opposing sides of the first pocket and a first side of the opposing sides of the second pocket each defined by a second attachment member of the plurality of attachment members with no other attachment members of the plurality of attachment members arranged between the first attachment member and the second attachment member.

10. The assembly of claim 8, wherein the lower folded edge of the insert further defines a lower closed end of a third pocket shaped to receive a third article, the terminating edge further defines an upper open end of the third pocket, and the plurality of attachment members further define opposing sides of the third pocket.

11. The assembly of claim 1, further comprising a spacer shaped to engage in face-sharing contact with a rearward surface of the insert opposite to the pocket.

12. An insert for a mailer, comprising:
a first side flap;
a second side flap arranged opposite to the first side flap across the insert;
a first set of attachment members including a first attachment member arranged at an exterior surface of the first side flap and a second attachment member arranged at an exterior surface of the second side flap; and
a second set of attachment members arranged between the first side flap and the second side flap, the second set of attachment members defining a set of pockets while the first side flap and the second side flap are joined to a panel of the insert via the first set of attachment members.

13. The insert of claim 12, wherein each pocket of the set of pockets includes a respective lower end closed by a folded edge of the panel and a respective open end defined by a terminal edge of the panel.

14. The insert of claim 12, wherein the second set of attachment members is arranged at an interior surface of the insert, and the first side flap and the second side flap overlap the interior surface while joined to the panel.

15. The insert of claim 14, wherein, while joined to the first side flap and the second side flap via the first set of attachment members, the panel joins to the interior surface via the second set of attachment members.

16. The insert of claim 15, wherein a thickness of the insert while the panel is joined to the first side flap, the second side flap, and the interior surface is less than 0.25 inches, a length of the insert from a folded edge of the first side flap to a folded edge of the second side flap is 9.5 inches or less, and a ratio of the length to a width of the insert is 1.4.

17. A method for an assembly for a mailer, comprising:
folding a first side flap and a second side flap of an insert to overlap a surface of the insert including a first attachment member and a second attachment member;
folding a panel of the insert to overlap the folded first side flap and the folded second side flap; and
joining the first attachment member and the second attachment member to the panel to define a set of pockets of the insert.

18. The method of claim 17, further comprising joining a third attachment member arranged at the first side flap and a fourth attachment member arranged at the second side flap to the panel.

19. The method of claim 17, further comprising assembling the assembly by arranging the insert with the first attachment member and the second attachment member joined to the panel between a backer and a spacer, where the backer and the spacer each have a respective thickness greater than a thickness of the insert.

20. The method of claim 19, further comprising seating a plurality of articles within the pockets of the set of pockets of the insert, and inserting the assembly into the mailer while maintaining the plurality of articles within the pockets.
